(19) United States
(12) Patent Application Publication
(10) Pub. No.: US 2025/0373352 A1
(43) Pub. Date: Dec. 4, 2025

(54) Real-Time Clock Device

(71) Applicant: SEIKO EPSON CORPORATION, Tokyo (JP)

(72) Inventor: Jun SHIINA, Minowa (JP)

(21) Appl. No.: 19/220,756

(22) Filed: May 28, 2025

(30) Foreign Application Priority Data
May 29, 2024 (JP) 2024-086859

(51) Int. Cl. H04J 3/06

(52) U.S. Cl. CPC H04J 3/0644

(57) ABSTRACT

A real-time clock device a real-time clock device that has a first mode and a second mode, the device including an input terminal to which a reference pulse signal of a time is input, an output terminal that outputs a synchronization pulse signal of the time, an oscillation circuit that outputs an oscillation clock signal, a clock count circuit that generates information on an internal time based on the oscillation clock signal, and a processing circuit that performs time correction of the internal time based on the reference pulse signal input from the input terminal and causes the output terminal to output the synchronization pulse signal generated based on the information on the internal time in the first mode, and performs the time correction of the internal time based on the reference pulse signal input from the input terminal in the second mode.

The present application is based on, and claims priority from JP Application Serial Number 2024-086859, filed May 29, 2024, the disclosure of which is hereby incorporated by reference herein in its entirety.

### BACKGROUND

### 1. Technical Field

The present disclosure relates to a real-time clock device or the like.

### 2. Related Art

A real-time clock device that generates time information by performing clocking based on an oscillation clock signal is known. For example, JP-A-2021-189037 discloses a method of correcting a sub-second by reading data of a lower counter of a sub-second at the timing according to a reference pulse signal to measure an error of clock data, and performing a distributed theoretical regulation on an upper counter of the sub-second.

When a system is constructed using a plurality of real-time clock devices, there is a problem that the system becomes complicated when time information is input from the outside, which is the system, to each real-time clock device to perform time synchronization.

### SUMMARY

According to an aspect of the present disclosure, there is provided a real-time clock device that has a first mode and a second mode, the device including an input terminal to which a reference pulse signal of a time is input, an output terminal that outputs a synchronization pulse signal of the time, an oscillation circuit that outputs an oscillation clock signal, a clock count circuit that generates information on an internal time based on the oscillation clock signal, and a processing circuit that performs time correction of the internal time based on the reference pulse signal input from the input terminal and causes the output terminal to output the synchronization pulse signal generated based on the information on the internal time in the first mode, and performs the time correction of the internal time based on the reference pulse signal input from the input terminal in the second mode.

### BRIEF DESCRIPTION OF THE DRAWINGS

FIG. 1 is a configuration example of a real-time clock device according to the present embodiment.

FIG. 2 is a system configuration example according to the present embodiment.

FIG. 3 is a detailed configuration example of the real-time clock device according to the present embodiment.

FIG. 4 is a signal waveform diagram illustrating an operation according to the present embodiment.

FIG. 5 is a flowchart illustrating the operation according to the present embodiment.

FIG. 6 is an explanatory diagram of a time correction control according to the present embodiment.

FIG. 7 is an explanatory diagram of the time correction control according to the present embodiment.

FIG. 8 is an explanatory diagram of a problem of a method according to a comparative example.

FIG. 9 is an explanatory diagram of a method of frequency correction and time correction according to the present embodiment.

FIG. 10 is an explanatory diagram of an input and output signal according to the present embodiment.

FIG. 11 is a detailed configuration example of the real-time clock device that realizes the frequency correction.

FIG. 12 is a signal waveform diagram illustrating the operation according to the present embodiment.

FIG. 13 is a flowchart illustrating the operation according to the present embodiment.

FIG. 14 is a flowchart illustrating the operation according to the present embodiment.

### DESCRIPTION OF EMBODIMENTS

Hereinafter, the present embodiment will be described. The present embodiment described below does not unreasonably limit the contents described in the aspects. In addition, not all configurations described in the present embodiment are essential configuration requirements.

### 1. Real-Time Clock Device

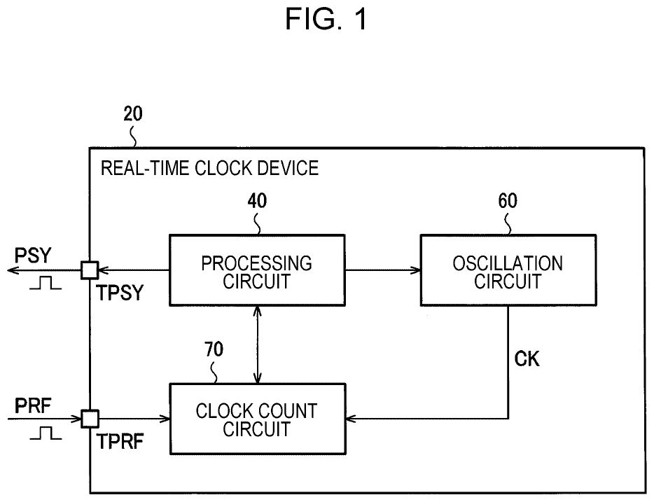

FIG. 1 illustrates a configuration example of a real-time clock device 20 according to the present embodiment. The real-time clock device 20 is a device that generates time information by performing clocking based on, for example, an oscillation clock signal CK, and is, for example, a real-time clock module. The real-time clock device 20 of FIG. 1 includes a processing circuit 40, an oscillation circuit 60, a clock count circuit 70, an input terminal TPRF of a reference pulse signal PRF, and an output terminal TPSY of a synchronization pulse signal PSY. The configuration of the real-time clock device 20 is not limited to the configuration of FIG. 1, and various modifications such as omitting some of the components, adding other components, and replacing some of the components with other components can be implemented.

The input terminal TPRF is a terminal to which the reference pulse signal PRF of the time is input. For example, the input terminal TPRF is an input terminal for external coupling provided in a package of the real-time clock device 20. The reference pulse signal PRF is a reference signal of the time. For example, the edge timing of the reference pulse signal PRF is a reference timing of the time, and is, for example, the timing indicating the hour. As an example of the reference pulse signal PRF, a 1 pulse per second (PPS) signal, which is a timing standard signal in GPS (GNSS) or the like, can be used. In the present embodiment, for example, a reference signal such as 1 PPS output by an external GPS module can be used as the reference pulse signal PRF, but the present disclosure is not limited thereto. For example, the signal may be a signal every 10 seconds, which is longer than one second, instead of a signal every second such as 1 PPS. In addition, when time information is transmitted for time synchronization of a plurality of communication devices communicatively connected via a network, a synchronization signal or the like of the time information may be used as the reference pulse signal PRF. For example, a signal obtained by time synchronization using NTP (Network Time Protocol) or PTP (Precision Time Protocol) may be used as the reference pulse signal PRF.

The output terminal TPSY is a terminal to which the synchronization pulse signal PSY of the time is output. For example, the output terminal TPSY is an output terminal for external coupling provided in a package of the real-time clock device 20. The synchronization pulse signal PSY is a signal that is a reference pulse signal of another real-time clock device outside the real-time clock device 20. For example, the synchronization pulse signal PSY is a signal for time synchronization of the real-time clock device 20 and another real-time clock device. For example, the edge timing of the synchronization pulse signal PSY is the timing corresponding to the edge timing of the reference pulse signal PRF. For example, when the voltage level of the reference pulse signal PRF changes at the edge timing, the voltage level of the synchronization pulse signal PSY also changes. However, the voltage level of the synchronization pulse signal PSY does not need to always change in the edge timing of the reference pulse signal PRF, and for example, the voltage level of the synchronization pulse signal PSY may change for every n (n is an integer of 2 or more) edge timings of the reference pulse signal PRF. For example, when the reference pulse signal PRF is a pulse signal in which the voltage level changes every predetermined time such as every second, the synchronization pulse signal PSY may be a pulse signal in which the voltage level changes every predetermined time such as every 10 seconds, every minute, or every hour.

The oscillation circuit 60 is a circuit that outputs the oscillation clock signal CK. For example, the oscillation circuit 60 generates an oscillation signal by an oscillation operation, and outputs an oscillation clock signal CK based on the oscillation signal. For example, the oscillation circuit 60 generates an oscillation signal having a frequency controlled by the frequency control signal from the processing circuit 40, and outputs an oscillation clock signal CK based on the oscillation signal. As an example, the oscillation circuit 60 generates a sine wave oscillation signal by driving a resonator such as a quartz crystal resonator to oscillate by a drive circuit, and outputs a rectangular wave oscillation clock signal CK by shaping the waveform of the oscillation signal generated by the waveform shaping circuit. For example, the oscillation clock signal CK is a clock signal having a frequency of 32.768 KHz. The frequency of the oscillation clock signal CK is not limited thereto, and may be a frequency such as 32 KHz. In addition, the real-time clock device 20 may have a clock output terminal that outputs the oscillation clock signal CK. The oscillation operation of the oscillation circuit 60 is not limited to the use of such a resonator, and various modifications can be made.

The processing circuit 40 is a circuit that performs various arithmetic processing, control processing, and the like in the real-time clock device 20. The processing circuit 40 can be realized by, for example, a logic circuit, and more specifically, by a circuit of an application specific integrated circuit (ASIC) by automatic arrangement wiring such as a gate array.

The clock count circuit 70 generates information on the internal time based on the oscillation clock signal CK from the oscillation circuit 60. For example, the clock count circuit 70 performs clock counting processing based on the frequency division clock signal obtained by dividing the oscillation clock signal CK by, for example, a frequency division circuit, and generates, for example, time information indicating the current time by the clock counting processing. For example, a frequency division clock signal having a frequency, for example, 1 Hz or 1 KHz is generated by dividing the oscillation clock signal CK by the frequency division circuit, and time information is generated by clock processing based on the frequency division clock signal. The time information, which is the clock data, can include data indicating a second, a minute, an hour, a day, a month, a year, and the like. For example, the clock count circuit 70 has each of the counters for counting each of a second, a minute, an hour, a day, a month, and a year, and generates time information by the counting processing of these counters. For example, the generated time information is output to the outside through an interface circuit or the like. In addition, information on the internal time corresponding to the time information is output from the clock count circuit 70 to the processing circuit 40.

The real-time clock device 20 of the present embodiment has a first mode and a second mode. For example, the real-time clock device 20 operates in the first mode when the control mode is set to the first mode, and operates in the second mode when the control mode is set to the second mode. The first mode is, for example, a master mode, and the second mode is, for example, a slave mode. The master is a real-time clock device on the side that outputs the synchronization pulse signal PSY, and the slave is a real-time clock device on the side that inputs the synchronization pulse signal PSY as the reference pulse signal PRF.

In the first mode, the processing circuit 40 performs time correction of the internal time based on the reference pulse signal PRF input from the input terminal TPRF, and outputs the synchronization pulse signal PSY generated based on the information on the internal time from the output terminal TPSY. In addition, in the second mode, the processing circuit 40 performs time correction of the internal time based on the reference pulse signal PRF input from the input terminal TPRF. The time correction is processing of updating the internal time of the real-time clock device 20 to an accurate time. For example, the edge timing of the reference pulse signal PRF is the timing on the hour, and the processing circuit 40 performs time correction for updating the information on the internal time so that the internal time is the time on the hour by using the reference pulse signal PRF.

For example, when the control mode is set to the first mode which is the master mode, the processing circuit 40 performs time correction of the internal time based on the reference pulse signal PRF input from the input terminal TPRF, and outputs the synchronization pulse signal PSY based on the information on the internal time obtained by the time correction in this manner from the output terminal TPSY. For example, the clock count circuit 70 has a counter such as a second, a minute, an hour, a day, a week, a month, and a year, and the processing circuit 40 generates the synchronization pulse signal PSY based on a clocking signal of the counter and outputs the synchronization pulse signal PSY from the output terminal TPSY. For example, the processing circuit 40 generates a synchronization pulse signal PSY activated each time a counter on seconds is incremented. Alternatively, the processing circuit 40 may generate a synchronization pulse signal PSY activated each time a counter for a minute, an hour, a day, a week, a month, or a year is incremented. Alternatively, the processing circuit 40 may generate the synchronization pulse signal PSY by a signal obtained by combining the clocking signals of a plurality of counters such as a second, a minute, an hour, a day, a week, a month, and a year.

On the other hand, when the control mode is set to the second mode which is the slave mode, the processing circuit 40 performs time correction of the internal time based on the reference pulse signal PRF input from the input terminal TPRF. For example, the synchronization pulse signal PSY output from another real-time clock device set to the first mode is input from the input terminal TPRF as the reference pulse signal PRF. Then, the processing circuit 40 performs time correction for updating the internal time to the accurate time based on the reference pulse signal PRF which is the synchronization pulse signal PSY from another real-time clock device.

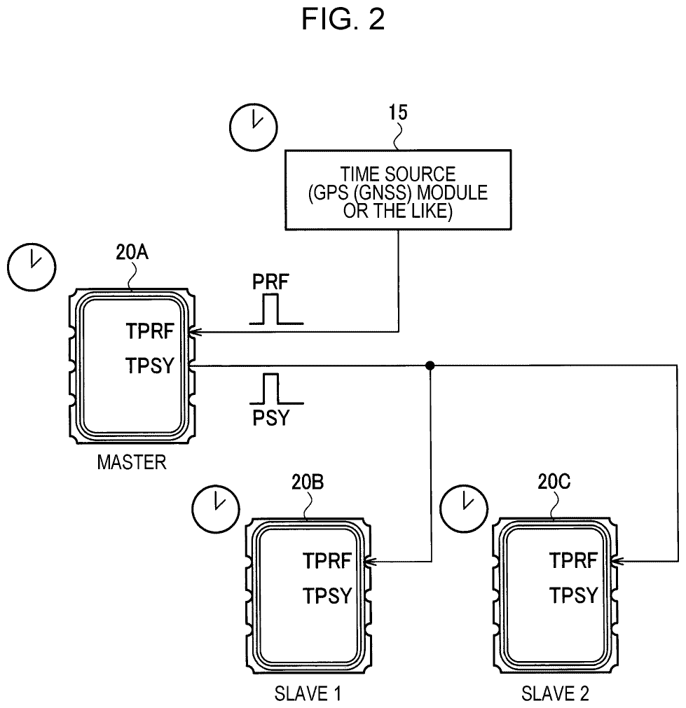

For example, FIG. 2 illustrates a system configuration example according to the present embodiment. In FIG. 2, a time source 15 outputs the reference pulse signal PRF. For example, the time source 15 is a GPS (GNSS) module or the like, but may be a time source using NTP or PTP. In FIG. 2, the real-time clock device 20A is set to the first mode to be a master, and the real-time clock devices 20B and 20C are set to the second mode to be slaves. Therefore, the real-time clock device 20A, which is the master, inputs the reference pulse signal PRF from the time source 15 to the input terminal TPRF, performs time correction of the internal time based on the reference pulse signal PRF, and outputs the synchronization pulse signal PSY from the output terminal TPSY. The real-time clock devices 20B and 20C, which are the slaves, input the synchronization pulse signal PSY from the real-time clock device 20A of the master to the input terminal TPRF, and perform time correction using the synchronization pulse signal PSY from the master as the reference pulse signal PRF. In this manner, the real-time clock device 20A of the master can maintain the internal time as an accurate time by performing the time correction of the internal time based on the reference pulse signal PRF from the time source 15. The real-time clock devices 20B and 20C of the slaves can maintain the internal time as an accurate time by performing the time correction of the internal time using the synchronization pulse signal PSY from the real-time clock device 20A of the master as the reference pulse signal PRF.

As described above, the real-time clock device 20 of the present embodiment includes the input terminal TPRF to which the reference pulse signal PRF of the time is input, the output terminal TPSY that outputs the synchronization pulse signal PSY of the time, the oscillation circuit 60 that outputs the oscillation clock signal CK, the clock count circuit 70 that generates the information on the internal time based on the oscillation clock signal CK, and the processing circuit 40. In the first mode, the processing circuit 40 performs time correction of the internal time based on the reference pulse signal PRF input from the input terminal TPRF, and outputs the synchronization pulse signal PSY generated based on the information on the internal time from the output terminal TPSY. In addition, in the second mode, the time correction of the internal time is performed based on the reference pulse signal PRF input from the input terminal TPRF. In this manner, in the first mode, the time correction of the internal time can be performed based on the reference pulse signal PRF input from the input terminal TPRF, and the time synchronization with another real-time clock device can be performed by outputting the synchronization pulse signal PSY from the output terminal TPSY. That is, the real-time clock device 20 itself can be a master to supply the synchronization pulse signal PSY to another real-time clock devices and perform the time synchronization. In addition, in the second mode, the time correction of the internal time can be performed using the synchronization pulse signal PSY output by another real-time clock device as the reference pulse signal PRF. Therefore, in the system having the plurality of real-time clock devices as illustrated in FIG. 2, the time synchronization can be performed without complicating the system, and the power consumption and the cost of the terminal device can be reduced.

For example, in the module of the real-time clock device 20, a time lag of the internal time occurs due to various factors such as the aging of the resonator and the frequency-temperature characteristics. In order to hold the accurate time, it is necessary to input the time information from an external time source as appropriate. However, when network communication such as a GPS module, NTP, and PTP is used as a time source for all the real-time clock devices, the configuration is complicated, and the cost and the current consumption increase. In addition, when the time information is appropriately input from the outside, it is necessary to activate the processing device such as the CPU that performs writing, and thus the current consumption of the system increases. In addition, in a case of a time correction method in which a first digital electronic timepiece on the correction side outputs a signal for time synchronization, and a second digital electronic timepiece on the side to be corrected detects the signal and performs time correction, since the master and the slave cannot be switched, the time of the entire network cannot be corrected when an abnormality occurs on the master side. In addition, in a case of a method of transmitting a pulse signal for starting or stopping processing in order to perform time synchronization between the master and the slave, since the same clock signal needs to be supplied, and the time information is not shared, the time information cannot be acquired as a log. In addition, in the time correction using packet communication such as NTP and PTP, when a packet is lost, the time correction accuracy is adversely affected.

In this regard, since the real-time clock device 20 of the present embodiment is a time synchronization by a pulse signal such as the reference pulse signal PRF or the synchronization pulse signal PSY, time synchronization can be performed without using a processing device such as a CPU for inputting time information, and power consumption can be reduced. In addition, time synchronization can be performed with a low current consumption by widening the output interval of the synchronization pulse signal PSY. In addition, even when the loss of the synchronization pulse signal PSY occurs, since the correction of the timing of the pulse signal that is not input is not performed only, there is an advantage that the accuracy of the time synchronization is not significantly adversely affected. In addition, since the master side as the time source and the slave side can be switched, there is an advantage that a countermeasure for an abnormality can be taken by switching between the master side and the slave side when the abnormality occurs on the master side.

### 2. Detailed Configuration Example

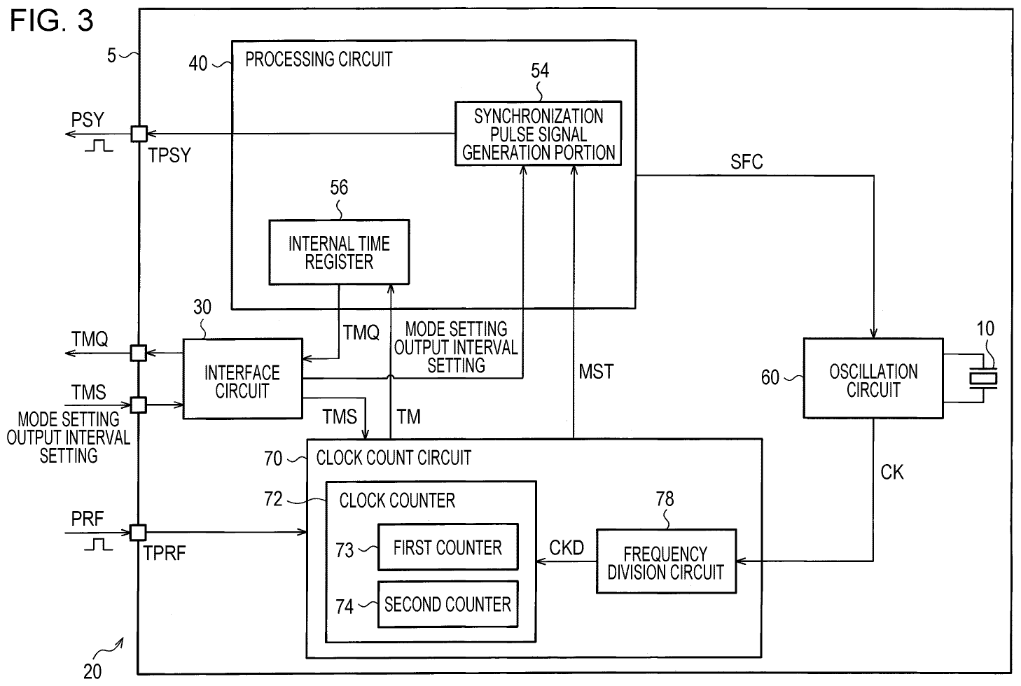

FIG. 3 illustrates a detailed configuration example of the real-time clock device 20 according to the present embodiment. In addition to the processing circuit 40, the oscillation circuit 60, and the clock count circuit 70, the real-time clock device 20 of FIG. 3 is provided with an interface circuit 30. In addition, FIG. 3 illustrates a detailed configuration example of the processing circuit 40 and the clock count circuit 70. The configurations of the real-time clock device 20, the processing circuit 40, and the clock count circuit 70 are not limited to the configurations of FIG. 3, and various modifications such as omitting some of the components, adding other components, and replacing some of the components with other components can be implemented.

In FIG. 3, the oscillation circuit 60 generates an oscillation signal by oscillating a resonator 10, and outputs the oscillation clock signal CK. The resonator 10 is an element that generates mechanical resonation by an electrical signal. The resonator 10 can be realized by a resonator element such as a quartz crystal resonator element. For example, the resonator 10 can be realized by a quartz crystal resonator element having a cut angle that thickness-shear resonates, such as an AT cut or an SC cut, a tuning fork type quartz crystal resonator element, a double tuning fork type quartz crystal resonator element, or the like. The resonator 10 of the present embodiment can also be realized by various resonator elements such as a resonator element other than a thickness-shear resonation type, a tuning fork type, a double tuning fork type, or a piezoelectric resonator element formed of a material other than quartz crystal. For example, as the resonator 10, a surface acoustic wave (SAW) resonator, a micro electro mechanical systems (MEMS) resonator as a silicon resonator formed by using a silicon substrate, or the like can be adopted.

For example, in the real-time clock device 20 of FIG. 3, an integrated circuit device including the interface circuit 30, the processing circuit 40, the oscillation circuit 60, the clock count circuit 70, and the like, and the resonator 10 are accommodated in the package 5. The integrated circuit device is a circuit device called an integrated circuit (IC). For example, the integrated circuit device is an IC manufactured by a semiconductor process, and is a semiconductor chip in which a circuit element is formed above a semiconductor substrate. The resonator 10 is electrically coupled to the integrated circuit device. For example, the resonator 10 and the integrated circuit device are electrically coupled to each other by using internal wiring of the package 5 that accommodates the resonator 10 and the integrated circuit device, a bonding wire, a metal bump, or the like. A modification in which the resonator 10 is not incorporated in the real-time clock device 20 and a resonator 10 provided outside is used can be performed.

The interface circuit 30 is a circuit for performing communication with an external processing device. For example, the interface circuit 30 performs communication based on a given communication standard with an external processing device. For example, the interface circuit 30 performs serial communication such as an inter-integrated circuit (I2C) or a serial peripheral interface (SPI). In the case of serial communication, the real-time clock device 20 includes a communication terminal such as a serial clock input terminal or a serial data input/output terminal. In FIG. 3, the time stamp information TMS, which is the time information, is input to the interface circuit 30. For example, the time stamp information TMS is input to the interface circuit 30 as serial data. In addition, the interface circuit 30 outputs the time information TMQ indicating the current time clocked by the real-time clock device 20.

For example, the oscillation circuit 60 can be realized by a drive circuit for oscillation electrically coupled to one end and the other end of the resonator 10, and a passive element such as a capacitor and a resistor. For example, the drive circuit can be realized by a bipolar transistor or a CMOS inverter circuit. The drive circuit is a core circuit of the oscillation circuit 60, and the drive circuit causes the resonator 10 to oscillate by voltage-driving or current-driving the resonator 10. As the oscillation circuit 60, various types of oscillation circuits such as an inverter type, a Pierce type, a Colpitts type, and a Hartley type can be used.

In addition, the oscillation circuit 60 may include a variable capacitance circuit (not illustrated). For example, the variable capacitance circuit includes a capacitor array having a plurality of capacitors and a switch array having a plurality of switches. Each capacitor of the plurality of capacitors and each switch of the plurality of switches are coupled in series between one end or the other end of the resonator 10 and, for example, a ground node. In addition, the plurality of capacitors of the capacitor array are weighted in binary in the capacitance value. The plurality of switches of the switch array are turned on and off based on the frequency control data which is the frequency control signal SFC from the processing circuit 40. As a result, the capacitance value of the variable capacitance circuit is controlled, and the oscillation frequency of the oscillation circuit 60 is adjusted. Alternatively, the variable capacitance circuit may be realized by, for example, a variable capacitance element such as a varactor. In this case, the frequency control voltage is input to the oscillation circuit 60 as the frequency control signal SFC from the processing circuit 40, and the capacitance of the variable capacitance element is adjusted by the frequency control voltage. Therefore, the oscillation frequency of the oscillation circuit 60 is adjusted. In addition, in the present embodiment, a temperature compensation circuit that performs temperature compensation processing based on the temperature detection signal from the temperature sensor may be provided. In this case, the capacitance of the variable capacitance circuit is adjusted based on the temperature compensation result in the temperature compensation circuit, and thus temperature compensation of the oscillation frequency is performed. The coupling in the present embodiment is an electrical coupling. The electrical coupling is a coupling in which an electrical signal is transmissible, and is a coupling in which information is transmissible by an electrical signal. The electrical coupling may be a coupling via a passive element or the like.

In FIG. 3, the clock count circuit 70 includes a clock counter 72 and a frequency division circuit 78. The frequency division circuit 78 divides the oscillation clock signal CK from the oscillation circuit 60 to generate a frequency division clock signal CKD. For example, the frequency division circuit 78 includes a frequency division counter that operates based on the oscillation clock signal CK, and the frequency division counter generates a frequency division clock signal CKD. For example, the frequency division clock signal CKD is a clock signal having a frequency of 1 Hz. The frequency division circuit 78 may include a first frequency division circuit that divides the oscillation clock signal CK at a first frequency division ratio, and a second frequency division circuit that divides the first frequency division clock signal from the first frequency division circuit at a second frequency division ratio to output a frequency division clock signal CKD which is the second frequency division clock signal. The first frequency division ratio is, for example, 32, and the frequency of the first frequency division clock signal is, for example, 1.024 KHz. The second frequency division ratio is, for example, 1024, and thus the frequency division clock signal CKD of 1 Hz is output from the frequency division circuit 78. The frequency of the frequency division clock signal CKD may be, for example, 1 KHz. In addition, any one of the oscillation clock signal CK, and the frequency division clock signal CKD, which is the first frequency division clock signal or the second frequency division clock signal, may be selected and output from the clock output terminal of the real-time clock device 20.

The clock counter 72 performs the clock counting processing based on the frequency division clock signal CKD from the frequency division circuit 78, and generates the information on the internal time TM. For example, the clock counter 72 has counters for a second, a minute, an hour, a day, a month, and a year, and generates the information on the internal time TM by the counting processing of these counters. The information on the internal time TM is stored in the internal time register 56 of the processing circuit 40 and is output to the outside via the interface circuit 30 as the time information TMQ indicating the current time. For example, the clock counter 72 includes a first counter 73 and a second counter 74. The first counter 73 is a counter that counts an hour, a minute, and a second, and the second counter 74 is a counter that counts less than a second. Details of the first counter 73 and the second counter 74 will be described later.

In addition, in FIG. 3, the processing circuit 40 includes a synchronization pulse signal generation portion 54 and an internal time register 56. The internal time register 56 stores the information on the internal time TM from the clock count circuit 70. The information on the internal time TM is output to the outside as the time information TMQ via the interface circuit 30.

The synchronization pulse signal generation portion 54 generates a synchronization pulse signal PSY. The generated synchronization pulse signal PSY is output to the outside via the output terminal TPSY. For example, the synchronization pulse signal generation portion 54 generates the synchronization pulse signal PSY based on a clocking signal MST from the clock count circuit 70. For example, the clocking signal MST is a signal indicating the count-up of a counter such as a second, a minute, or an hour provided in the clock count circuit 70. For example, the synchronization pulse signal generation portion 54 generates a synchronization pulse signal PSY activated at the timing of counting up the counter. For example, when the synchronization pulse signal PSY activated at the timing of the count-up of the counter on seconds is generated, the synchronization pulse signal PSY activated every second can be generated. Similarly, when the synchronization pulse signal PSY activated at the timing of the count-up of the time counter is generated, the synchronization pulse signal PSY activated every minute and every hour can be generated. In addition, when the clock count circuit 70 has a counter such as a second, a minute, an hour, a day, a week, a month, and a year, the synchronization pulse signal generation portion 54 may generate the synchronization pulse signal PSY based on a signal obtained by combining the count-up signals from the counters. As a result, the synchronization pulse signal PSY can be generated in various aspects such as being activated every 10 seconds or every 20 seconds, being activated every one minute and 30 seconds, every 10 minutes, and every 15 minutes, and being activated every one hour and 20 minutes, every two hours, and every 12 hours.

In addition, information on mode setting and output interval setting is input to the synchronization pulse signal generation portion 54. The information on the mode setting and the output interval setting is input and set, for example, from an external processing device via the interface circuit 30. For example, the information on the mode setting is information for setting a control mode such as a first mode or a second mode. For example, when the first mode is set by the information on the mode setting, the real-time clock device 20 operates in the first mode which is the master mode. In addition, when the second mode is set by the information on the mode setting, the real-time clock device 20 operates in the second mode which is the slave mode. In addition, the information on the output interval setting is information for setting the output interval of the synchronization pulse signal PSY. For example, when the output interval of one second is set, the synchronization pulse signal PSY activated every second is generated. Similarly, when the output intervals of one minute and one hour are set, the synchronization pulse signal PSY activated every minute and every hour is generated. The setting of the output interval is not limited to one second, one minute, and one hour, and the synchronization pulse signal PSY having various output intervals can be generated by combining a plurality of count-up signals as described above.

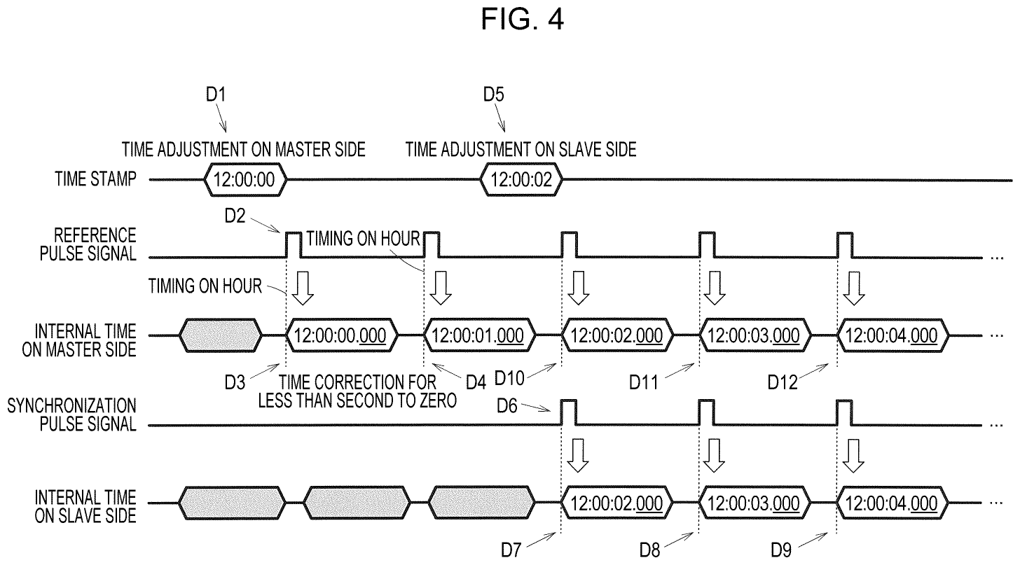

FIG. 4 is a signal waveform diagram illustrating an operation of the real-time clock device 20 of FIG. 3. As illustrated in D1 of FIG. 4, the time adjustment on the master side is first performed. For example, when the real-time clock device 20 is set to the first mode and is set on the master side, the initial time adjustment is performed using, for example, the time stamp information TMS. That is, when the time of [12:00:00] is input by the time stamp information TMS, the time of [12:00:00] is set as the internal time of the real-time clock device 20 on the master side. As illustrated in D2, the input of the reference pulse signal PRF is started, and the time correction is executed as illustrated in D3 and D4, for example, at the input timing of the reference pulse signal PRF. The input timing, which is the edge timing of the reference pulse signal PRF, is set to the timing on the hour, and the time correction is executed at the input timing on the hour of the reference pulse signal PRF. For example, the time correction for resetting less than a second to zero is executed. Specifically, the time correction for resetting the counter for less than a second of the clock count circuit 70 is executed.

After such a time adjustment on the master side, the time adjustment on the slave side is performed as illustrated in D5. For example, the real-time clock device 20 on the master side set to the first mode generates and outputs the synchronization pulse signal PSY as illustrated in D6, and the synchronization pulse signal PSY is input to the real-time clock device 20 on the slave side set to the second mode. The real-time clock device 20 on the slave side performs time correction using the synchronization pulse signal PSY as the reference pulse signal. For example, at the input timing of the synchronization pulse signal PSY, time correction for resetting less than a second to zero is executed. Specifically, the time correction for resetting the counter for less than a second of the clock count circuit 70 is executed. At this time, the real-time clock device 20 on the master side executes the time correction based on, for example, the reference pulse signal PRF as illustrated in D10, D11, and D12.

As described above, as illustrated in FIG. 2, the reference pulse signal PRF from the time source 15 may be input only to the real-time clock device 20 (20A) on the master side, and may not be input to the real-time clock device 20 (20B, 20C) on the slave side. As a result, the system configuration can be simplified, and the cost and power consumption can be reduced. For example, by providing one real-time clock device as a master side and a plurality of real-time clock devices as a slave side, the system configuration can be significantly simplified. For example, in the system of FIG. 2, the real-time clock device 20 is provided for each of a plurality of electronic devices (terminal devices). The real-time clock device 20 provided in the first electronic device is set to the first mode to be the master side, and the real-time clock devices 20 provided in the second electronic device to the N-th electronic device are set to the second mode to be the slave side. In the first electronic device, the reference pulse signal PRF from the time source is input to the real-time clock device 20. On the other hand, in the second electronic device to the N-th electronic device, it is not necessary to provide the time source, or it is not necessary to input the reference pulse signal PRF from the time source to the real-time clock device 20. As a result, the system can be simplified and miniaturized, and power consumption can be reduced.

In addition, in FIG. 4, the input interval of the reference pulse signal PRF and the output interval of the synchronization pulse signal PSY are the same as each other, but in the present embodiment, for example, the output interval of the synchronization pulse signal PSY may be longer than the input interval of the reference pulse signal PRF. For example, when the input interval of the reference pulse signal PRF is an interval of one second, the output interval of the synchronization pulse signal PSY can be set to a long interval such as 10 seconds, one minute, and one hour. When the output interval of the synchronization pulse signal PSY is lengthened in this manner, the generation interval of the synchronization pulse signal PSY on the master side is lengthened, and the interval of the time correction based on the synchronization pulse signal PSY on the slave side is also lengthened. Therefore, the power consumption can be reduced as compared with a case where the reference pulse signal PRF having the same input interval is input to all the real-time clock devices 20.

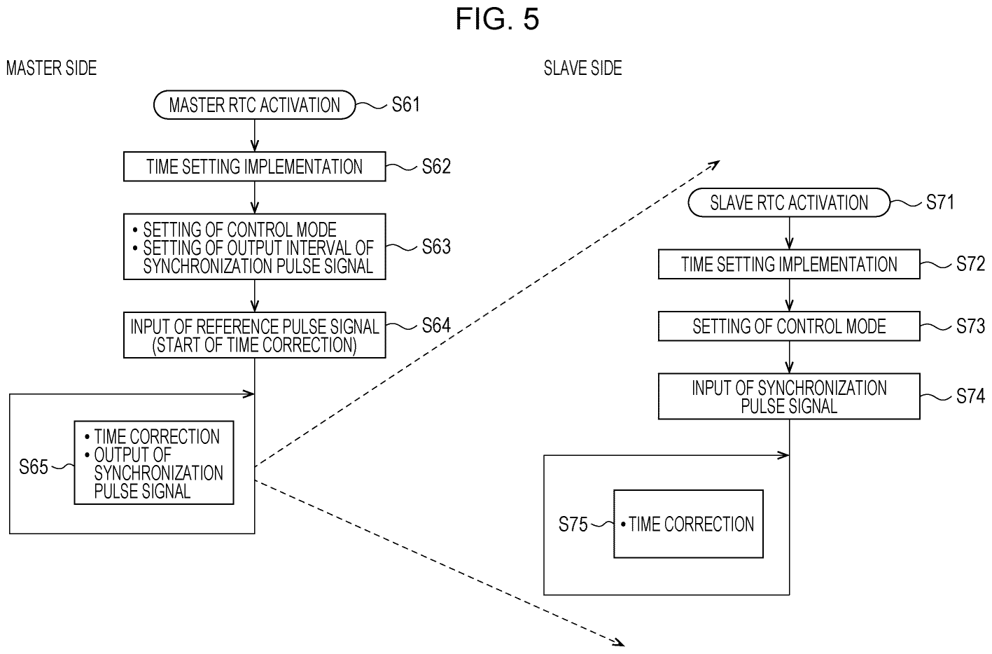

FIG. 5 is a flowchart illustrating the operation of the real-time clock device 20 according to the present embodiment. When the power is turned on and the real-time clock device 20 on the master side is activated, the time setting of the real-time clock device 20 on the master side is performed (steps S61 and S62). For example, the time adjustment is performed based on the time stamp information TMS as illustrated in D1 of FIG. 4. The setting of the control mode of the real-time clock device 20 and the setting of the output interval of the synchronization pulse signal PSY are performed (step S63). For example, when information on the setting of the control mode or setting of the output interval is input from an external processing device via the interface circuit 30, the control mode of the real-time clock device 20 is set or the output interval of the synchronization pulse signal PSY is set. As illustrated in D2 of FIG. 4, the input of the reference pulse signal PRF is started, the time correction is executed as illustrated in D3 and D4, and the synchronization pulse signal PSY is output as illustrated in D6 (steps S64 and S65).

Next, the real-time clock device 20 on the slave side is activated, the time is set, and the control mode of the real-time clock device 20 is set (steps S71, S72, and S73). As illustrated in D6 of FIG. 4, when the synchronization pulse signal PSY is input, the time correction in the real-time clock device 20 on the slave side is executed by using the synchronization pulse signal PSY (steps S74 and S75).

As described above, in the present embodiment, the processing circuit 40 sets the output interval of the synchronization pulse signal PSY in the first mode. For example, as illustrated in step S63 of FIG. 5, the processing circuit 40 of the real-time clock device 20 on the master side set to the first mode sets the output interval of the synchronization pulse signal PSY. For example, the processing circuit 40 sets the output interval of the synchronization pulse signal PSY to an interval longer than the input interval of the reference pulse signal PRF. The processing circuit 40 outputs the synchronization pulse signal PSY from the output terminal TPSY at the set output interval. In this manner, the real-time clock device 20 outputs the synchronization pulse signal PSY at an output interval different from the input interval of the reference pulse signal PRF, and can perform time synchronization with another real-time clock device. For example, low power consumption can be realized by increasing the output interval of the synchronization pulse signal PSY. For example, the generation interval of the synchronization pulse signal PSY of the synchronization pulse signal generation portion 54 is lengthened, or the interval of the time correction based on the synchronization pulse signal PSY in the real-time clock device 20 on the slave side is lengthened, and thus low power consumption can be realized.

In addition, as illustrated in FIG. 3, the real-time clock device 20 includes the interface circuit 30 to which the output interval setting information is input, and the processing circuit 40 sets the output interval of the synchronization pulse signal PSY based on the output interval setting information input via the interface circuit 30. The output interval setting information is received by the interface circuit 30 via a data line such as serial communication, for example, and the received output interval setting information is input to the processing circuit 40 and written in a register provided in the processing circuit 40, for example. The synchronization pulse signal generation portion 54 of the processing circuit 40 generates the synchronization pulse signal PSY having an output interval set according to the output interval setting information. In this manner, the output interval of the synchronization pulse signal PSY is set by the processing device or the like outside the real-time clock device 20, and the time synchronization of the plurality of real-time clock devices can be realized by the synchronization pulse signal PSY generated at the set output interval.

In addition, the real-time clock device 20 includes the interface circuit 30 into which the mode setting information is input, and the processing circuit 40 sets the control mode of the real-time clock device 20 to the first mode or the second mode based on the mode setting information input via the interface circuit 30. The mode setting information is received by the interface circuit 30 via a data line such as serial communication, for example, and the received mode setting information is input to the processing circuit 40 and written in the register provided in the processing circuit 40, for example. The processing circuit 40 sets the control mode of the real-time clock device 20 to the first mode or the second mode according to the mode setting information. For example, when the control mode is set to the first mode, the processing circuit 40 performs time correction of the internal time based on the reference pulse signal PRF input from the input terminal TPRF, and outputs the synchronization pulse signal PSY generated based on the information on the internal time from the output terminal TPSY. On the other hand, when the control mode is set to the second mode, the processing circuit 40 performs time correction of the internal time using the synchronization pulse signal PSY input from the input terminal TPRF as the reference pulse signal PRF. In this manner, the control mode of the real-time clock device 20 can be set by an external processing device or the like, and the real-time clock device 20 can be operated in the set control mode. For example, the control mode can be set to the first mode to operate the real-time clock device 20 as the master, or the control mode can be set to the second mode to operate the real-time clock device 20 as the slave.

In addition, the real-time clock device 20 includes the interface circuit 30 to which the time stamp information TMS is input. The processing circuit 40 outputs the synchronization pulse signal PSY from the output terminal TPSY after setting the information on the internal time by the time stamp information TMS input via the interface circuit 30. For example, as illustrated in D1 of FIG. 4, the time stamp information TMS is input via the interface circuit 30, and the time adjustment of the internal time of the real-time clock device 20 on the master side is performed. For example, in FIG. 4, the internal time of the real-time clock device 20 on the master side is set to [12:00:00] instructed by the time stamp information TMS. After the internal time is set according to the time stamp information TMS, the synchronization pulse signal PSY is output from the real-time clock device 20 on the master side to the real-time clock device 20 on the slave side as illustrated in D6. Specifically, in FIG. 4, the time correction of the internal time of the real-time clock device 20 on the master side is performed by the reference pulse signal PRF, and then the synchronization pulse signal PSY is output. In this manner, after the internal time of the real-time clock device 20 set to the first mode is set to an appropriate time by the time stamp information TMS, the synchronization pulse signal PSY based on the information on the internal time can be output to the real-time clock device 20 set to the second mode. Therefore, the time synchronization with the real-time clock device 20 set to the first mode and the real-time clock device 20 set to the second mode can be realized by the synchronization pulse signal PSY based on more accurate internal time information.

In addition, the clock count circuit 70 generates time information, which is information on at least any one of a second, a minute, an hour, a day, a week, a month, and a year, as the internal time information. The processing circuit 40 generates the synchronization pulse signal PSY based on the generated time information in this manner. For example, the clock count circuit 70 includes a clock counter 72 having a counter for at least one of a second, a minute, an hour, a day, a week, a month, and a year, and time information based on the output from the clock counter 72 is input to the processing circuit 40. For example, as illustrated in FIG. 3, the clocking signal MST of the clock counter 72 is input to the processing circuit 40 as the time information on the internal time, and the processing circuit 40 generates the synchronization pulse signal PSY based on the clocking signal MST which is the time information. In this manner, the synchronization pulse signal PSY is generated by using the time information on the internal time generated by the clock count circuit 70, and the time synchronization with another real-time clock device set to the second mode can be realized. For example, the synchronization pulse signal PSY activated in any of the time units such as a second, a minute, an hour, a day, a week, a month, and a year can be generated, and the time synchronization with another real-time clock device in any of the time units such as a second, a minute, an hour, a day, a week, a month, and a year can be realized.

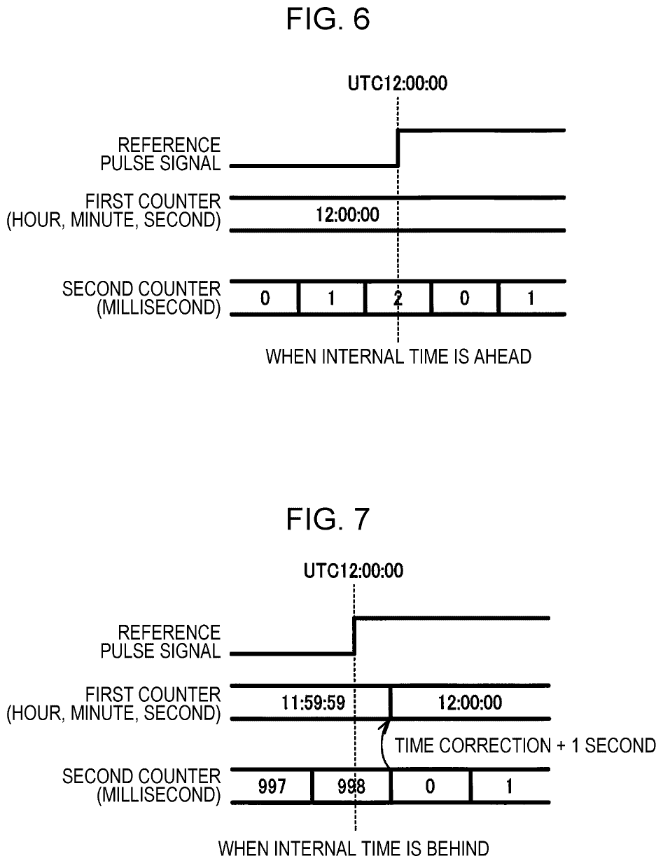

Next, the time correction of the present embodiment will be described in detail. FIGS. 6 and 7 are explanatory diagrams of time correction control according to the present embodiment. For example, as illustrated in FIG. 3, the clock count circuit 70 is provided with a first counter 73 that counts an hour, a minute, and a second, and a second counter 74 that counts less than a second. For example, a counter that counts each of the hour, minute, and second is provided as the first counter 73, and a counter that counts milliseconds is provided as the second counter 74.

In FIG. 6, the internal time of the real-time clock device 20 is ahead of the hour of [12:00:00] indicated by the reference pulse signal PRF. That is, the first counter 73, that counts an hour, a minute, and a second, indicates [12:00:00], but since the second counter 74, which counts the milliseconds less than a second, for example, has a count value of 2, the internal time is ahead by, for example, 2 milliseconds. When it is determined that the internal time is ahead of the time corresponding to the reference pulse signal PRF in this manner, in the time correction, the count value of the second counter 74 is reset (cleared) to, for example, 0 as illustrated in FIG. 6.

On the other hand, in FIG. 7, the internal time of the real-time clock device 20 is behind the hour of [12:00:00] indicated by the reference pulse signal PRF. That is, the first counter 73, that counts an hour, a minute, and a second, indicates [11:59:59], and since the second counter 74, which counts the milliseconds less than a second, for example, has a count value of “998”, the internal time is behind by, for example, 2 milliseconds. When it is determined that the internal time is behind the time corresponding to the reference pulse signal PRF in this manner, in the time correction, the count value of the second counter 74 is reset to, for example, 0 as illustrated in FIG. 7, and a value corresponding to one second is added to the count value of the first counter 73. For example, the count value of the counter on seconds of the first counter 73 is incremented only by, for example, 1. In this manner, even when the internal time is ahead or behind at the timing when the reference pulse signal PRF is input, time correction for setting the count values of the first counter 73 and the second counter 74 to the count values corresponding to the hour can be executed. That is, when the internal time is ahead, as illustrated in FIG. 6, the count value of the second counter 74 that counts less than a second is reset, and the count value of the first counter 73 that counts an hour, a minute, and a second is left as it is, so that the count value can be set to the count value corresponding to the hour. In addition, when the internal time is behind, as illustrated in FIG. 7, the count value of the second counter 74 that counts less than a second is reset, and the count value of the first counter 73 that counts an hour, a minute, and a second is set to +1 second, so that the count value can be set to the count value corresponding to the hour.

As described above, the clock count circuit 70 includes the first counter 73 that counts an hour, a minute, and a second, and the second counter 74 that counts less than a second. For example, the first counter 73 includes a counter that counts each of an hour, a minute, and a second, and the second counter 74 includes a counter that counts less than a second, such as a counter on milliseconds. As described in FIG. 6, when the internal time is ahead of the time corresponding to the reference pulse signal PRF, the processing circuit 40 resets the count value of the second counter 74 in the time correction. For example, the count value of the counter on milliseconds is reset. On the other hand, as described with reference to FIG. 7, when the internal time is behind the time corresponding to the reference pulse signal PRF, the processing circuit 40 adds a value corresponding to one second to the count value of the first counter 73 in the time correction, and resets the count value of the second counter 74. For example, the count value of the counter on seconds of the first counter 73 is incremented by, for example, 1, and the count value of the counter on milliseconds of the second counter 74 is reset. In this manner, even when the internal time is ahead or behind at the timing when the reference pulse signal PRF is input, time correction for setting the count values of the first counter 73 and the second counter 74 to the count values corresponding to the hour can be executed.

### 3. Frequency Correction

The real-time clock device 20 of the present embodiment can perform the time correction of the internal time described above, and can also perform the frequency correction of the oscillation clock signal CK. Hereinafter, a method of the present embodiment when such processing is performed will be described in detail.

For example, in the present embodiment, the processing circuit 40 performs the frequency correction of the oscillation clock signal CK based on the time lag amount and the time interval of the time lag, and the time correction of the internal time, when it is determined that the time lag occurs at the internal time in a case in which the reference pulse signal PRF is input. For example, the processing circuit 40 monitors the internal time of the real-time clock device 20 at each timing when the reference pulse signal PRF is input, and determines whether or not the time lag occurs at the internal time. For example, the processing circuit 40 determines whether or not the time lag occurs at the internal time based on the information on the internal time generated by the clock processing of the clock count circuit 70. For example, when the internal time obtained by the clock processing of the clock count circuit 70 is strictly accurate, the internal time at each input timing of the reference pulse signal PRF matches the hour, and the time lag does not occur. However, when a situation such as the frequency of the oscillation clock signal CK changes due to the aging occurs, a time lag in which the internal time deviates from the hour occurs. When it is determined that such a time lag of the internal time occurs, the processing circuit 40 performs frequency correction of the oscillation clock signal CK based on the time lag amount and the time interval of the time lag. The time lag amount represents the time lag amount of the internal time, and is, for example, a time error of the internal time. In addition, the time interval of the time lag is a time interval indicating a length of a period in which the time lag having the time lag amount occurs. In addition, the processing circuit 40 performs time correction of the internal time when it is determined that the time lag of the internal time occurs. For example, the processing circuit 40 outputs a signal for instructing the execution of the time correction of the internal time to the clock count circuit 70, and the clock count circuit 70 that receives the signal performs processing of correcting (updating) the internal time to the accurate time.

In this manner, when the time lag occurs in the internal time of the real-time clock device 20, the time correction of the internal time is performed, and the frequency correction of the oscillation clock signal CK used for the clock processing of the internal time is performed. As a result, for example, even when the oscillation frequency of the oscillation circuit 60 is shifted due to the aging or the like, the real-time clock device 20 that can prevent the error in the clock count caused by the shift in the oscillation frequency and provide highly accurate time information can be realized. The frequency correction of the oscillation clock signal CK and the time correction of the internal time do not need to be performed at the same timing, and for example, the time correction of the internal time may be performed at the timing when the reference pulse signal PRF is next input after the frequency correction is performed.

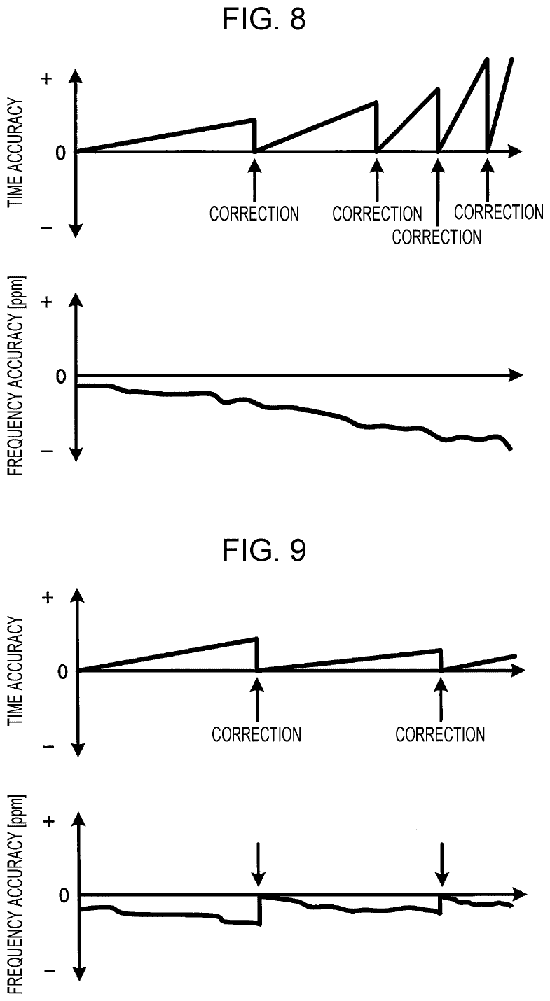

For example, FIG. 8 is an explanatory diagram of a problem of a method according to a comparative example of the present embodiment. In FIG. 8, the frequency error corresponding to the frequency accuracy of the oscillation increases over time due to the aging or the like, and the lag occurs in the internal time due to the frequency error. The correction for eliminating the lag of the internal time caused by such a frequency error is performed. In this case, since the frequency error increases over time, the lag of the internal time also increases, and the frequent correction of the internal time is required.

For example, in a module of a real-time clock (RTC) of one package in the related art, the frequency offset increases over time due to the aging of the resonator which is an internal resonance element, and the time lag is accelerated accordingly. In a state where the time lag is large, in order to maintain highly accurate time information, since it is necessary to frequently perform corrections for updating the time information as illustrated in FIG. 8, it is difficult to provide a highly accurate time.

On the other hand, in order to realize a highly accurate time, a method of performing a theoretical regulation correction of the clock count may be considered. However, since the frequency adjustment is not performed in the theoretical regulation, the clock accuracy remains poor when the clock signal is output from the real-time clock module.

In addition, an oscillator that has a function of detecting an error with the expected frequency based on the reference pulse signal of the GPS module which is a GPS receiver, and executing the frequency correction based on the detection result is also considered, but the oscillator does not perform the time correction using the reference pulse signal.

In addition, in order to realize an accurate clocking clock, a method of performing frequency adjustment of the clock generation circuit by a processing device such as an MCU without using a real-time clock module of one package may be considered. However, in this method, the size and the power consumption of the device become larger than those of the real-time module of one package. In addition, since the frequency adjustment is performed only by the time comparison, there is a problem that the frequency adjustment can be performed only up to the time resolution of the time stamp.

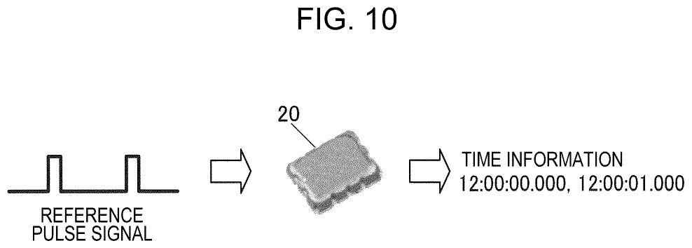

In this regard, in the present embodiment, the input terminal TPRF of the reference pulse signal PRF for correcting both the time and the frequency is provided. It is determined whether or not the time lag occurs in the internal time at the input timing of the reference pulse signal PRF input to the input terminal TPRF, and when it is determined that the time lag occurs, the frequency correction of the oscillation clock signal CK and the time correction of the internal time are executed. For example, the internal time of the real-time clock device 20 is corrected based on the reference pulse signal PRF, and the frequency is corrected based on the lag between the time indicated by the reference pulse signal PRF and the internal time of the real-time clock device 20. Therefore, both the time and the frequency are corrected using only the reference pulse signal PRF. As a result, as illustrated in FIG. 9, the time correction for updating the internal time to the accurate time is performed, and the frequency correction for bringing the frequency error close to zero is performed. Therefore, the real-time clock device 20 that can provide accurate time information and maintain time accuracy can be provided. In addition, as illustrated in FIG. 10 in the present embodiment, the frequency correction of the oscillation clock signal CK and the time correction of the internal time are performed by inputting the reference pulse signal PRF to the real-time clock device 20. Therefore, the real-time clock device 20, which is a real-time clock module of one package, is incorporated with the correction function of the internal time and the correction function of adjusting the oscillation frequency, and highly accurate time information can be provided with a small size and low power consumption.

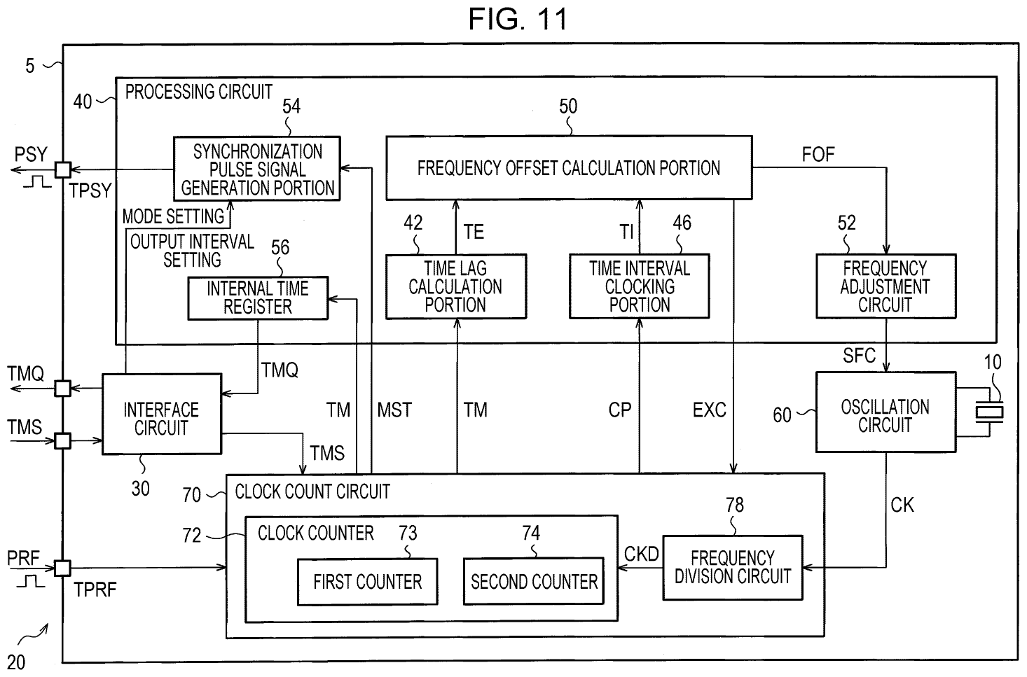

FIG. 11 is a detailed configuration example of the real-time clock device 20 when the time correction of the internal time and the frequency correction of the oscillation clock signal CK are performed. In FIG. 11, the processing circuit 40 includes a time lag calculation portion 42, a time interval clocking portion 46, a frequency offset calculation portion 50, a frequency adjustment circuit 52, a synchronization pulse signal generation portion 54, and an internal time register 56.

The time lag calculation portion 42 calculates the time lag of the internal time TM based on the internal time TM at the timing when the reference pulse signal PRF is input. For example, the timing when the reference pulse signal PRF is input is an edge timing of the reference pulse signal PRF. For example, the time lag calculation portion 42 determines whether or not the time lag occurs by performing the comparison processing based on the value of the internal time TM of the reference pulse signal PRF at the first input timing and the value of the internal time TM of the reference pulse signal PRF at the second input timing after the first input timing. The time lag calculation portion 42 outputs the time lag amount TE to the frequency offset calculation portion 50 when it is determined that the time lag occurs.

The time interval clocking portion 46 clocks the time interval TI in which the time lag occurs, and outputs the clocked time interval TI to the frequency offset calculation portion 50. For example, the time interval clocking portion 46 clocks the time interval from when the time correction is performed to the timing when it is determined that the time lag occurs next as the time interval TI of the time lag. For example, the time interval clocking portion 46 clocks the time interval from the timing when it is determined that there is no time lag of the internal time TM to the timing when it is determined that the time lag of the internal time TM occurs as the time interval TI of the time lag. For example, at the i-th input timing of the reference pulse signal PRF, it is determined that there is no time lag of the internal time TM, and it is determined that the time lag occurs at the j-th input timing of the reference pulse signal PRF (i and j are integers such thatj>i). In this case, the period from the i-th input timing to the j-th input timing is clocked as the time interval TI. For example, the clock count circuit 70 outputs the count pulse CP activated every input timing of the reference pulse signal PRF. The time interval clocking portion 46 clocks the time interval TI by counting the number of the count pulses CP. For example, when it is determined that there is no time lag at the i-th input timing and the time lag occurs at the j-th input timing, the time interval clocking portion 46 counts the number of the count pulses CP from the i-th input timing to the j-th input timing to clock the time interval TI of the time lag.

The frequency offset calculation portion 50 performs a calculation for estimating the frequency offset FOF based on the time lag amount TE from the time lag calculation portion 42 and the time interval TI of the time lag from the time interval clocking portion 46. For example, the frequency offset calculation portion 50 obtains the frequency offset as FOF=TE/TI. The frequency adjustment circuit 52 adjusts the frequency of the oscillation circuit 60 based on the frequency offset FOF. For example, the frequency adjustment circuit 52 performs frequency correction so as to cancel the estimated frequency offset FOF. For example, the frequency adjustment circuit 52 generates a frequency control signal SFC for increasing or decreasing the frequency of the oscillation clock signal CK by the amount of the obtained frequency offset FOF, and outputs the frequency control signal SFC to the oscillation circuit 60. The oscillation circuit 60 outputs the oscillation clock signal CK having an oscillation frequency corresponding to the frequency offset FOF. For example, the capacitance of the variable capacitance circuit of the oscillation circuit 60 is controlled by the frequency control signal SFC based on the frequency offset FOF, and thus the oscillation clock signal CK having the oscillation frequency corresponding to the frequency offset FOF is generated.

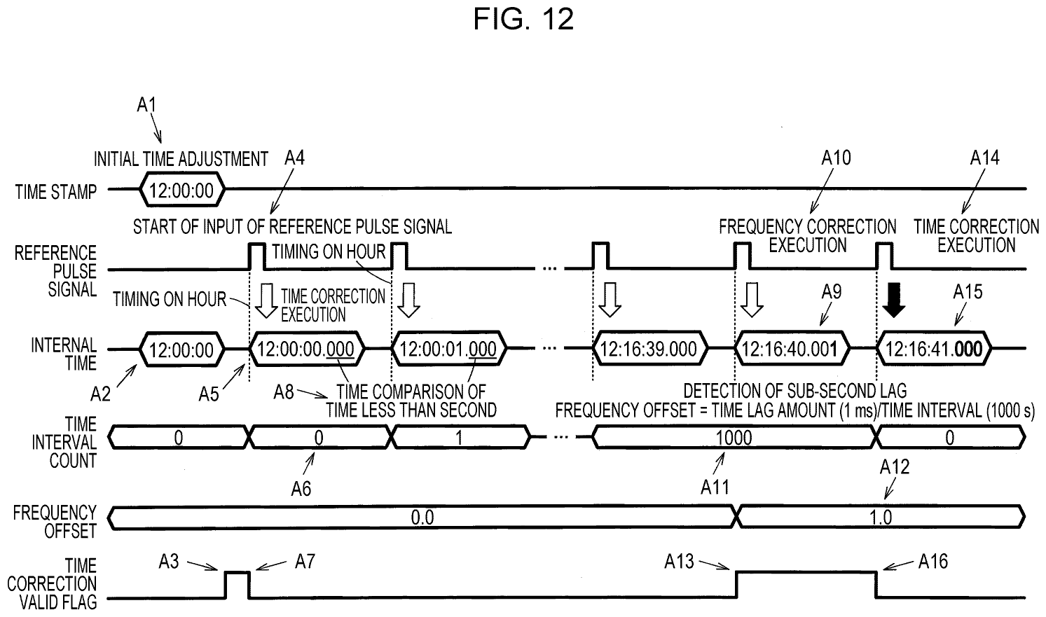

FIG. 12 is a signal waveform diagram illustrating the operation of the real-time clock device 20 of FIG. 11. In the initial time adjustment illustrated in A1 of FIG. 12, the time adjustment is performed by the time stamp information TMS. For example, when the time of [12:00:00] is input by the time stamp information TMS, the time of [12:00:00] is set as the internal time of the real-time clock device 20, as illustrated in A2. When the initial time adjustment is performed, the time correction valid flag is set to, for example, 1 as illustrated in A3, and the time correction is enabled.

As illustrated in A4, the input of the reference pulse signal PRF is started, and the time correction is executed as illustrated in A5, for example, at the initial input timing of the reference pulse signal PRF. The input timing, which is the edge timing of the reference pulse signal PRF, is set to the timing on the hour, and the time correction is executed at the input timing on the hour of the reference pulse signal PRF. For example, time correction for resetting the counter for less than a second of the clock count circuit 70 is executed. When the time correction is executed, the increment processing of the time interval count for every input timing of the reference pulse signal PRF is started as illustrated in A6, and the time correction flag is cleared (reset) to, for example, 0 as illustrated in A7.

The initial time adjustment is performed, the time correction is executed, and then the time comparison of the time less than a second is performed as illustrated in A8 at the input timing of the reference pulse signal PRF to detect the time lag. For example, it is determined whether or not the time lag occurs by detecting whether or not the last digit of 000 of less than a second (1 ms) changes from 0 to 1, for example. In A9, the sub-second lag, which is the time lag, is detected by comparing the time less than a second of the internal time. Specifically, as illustrated in A9, it is detected that the time lag of 1 ms occurs at the internal time at the input timing of the reference pulse signal PRF. That is, since the input timing of the reference pulse signal PRF is the timing on the hour, the time less than a second is required to be 000, but in A9, it is 001, and thus it is determined that the time lag, which is the sub-second lag, occurs. In the present embodiment, the accuracy of the time lag is described as 1 ms. For example, by providing a counter for milliseconds as the clock counter 72, an accuracy of 1 ms can be achieved. However, the accuracy of the time lag may be shorter than 1 ms or may be longer than 1 ms.

When it is determined that the time lag of the internal time occurs in this manner, the frequency correction of the oscillation clock signal CK is executed as illustrated in A10. Specifically, the frequency offset FOF=TE/TI=time lag amount/time interval is obtained, and the frequency correction of the oscillation clock signal CK is executed based on the obtained frequency offset FOF. For example, as illustrated in A9, the time lag amount TE is 1 ms. In addition, as illustrated in A11, the value of the time count is incremented from 0 to 1000, and thus the time interval TI of the time lag becomes 1000 s in 1000 counts x 1 second. Therefore, as illustrated in A12, the frequency offset FOF=1 ms/1000 s=1 ppm is obtained, and the frequency correction of the oscillation clock signal CK is executed based on the frequency offset FOF. By executing the frequency correction, the time correction valid flag is set to 1 as illustrated in A13. As a result, as illustrated in A14, the time correction is executed at the timing when the reference pulse signal PRF is next input. Specifically, as illustrated in A15, the time less than a second of the internal time is reset to 000. For example, a counter on milliseconds is reset. When the time correction is executed In this manner, the time correction valid flag is cleared to 0 as illustrated in A16.

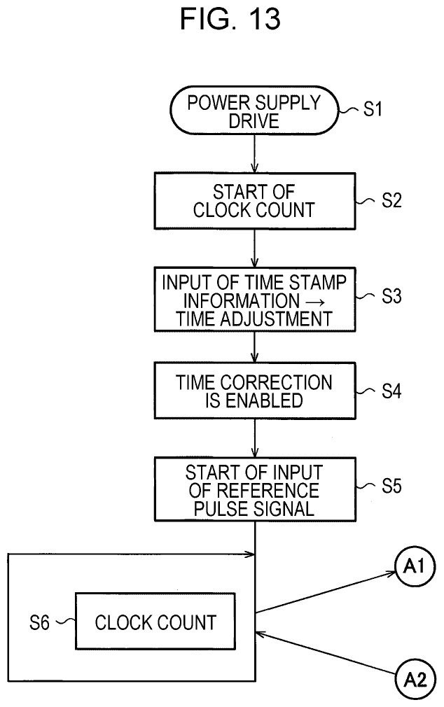

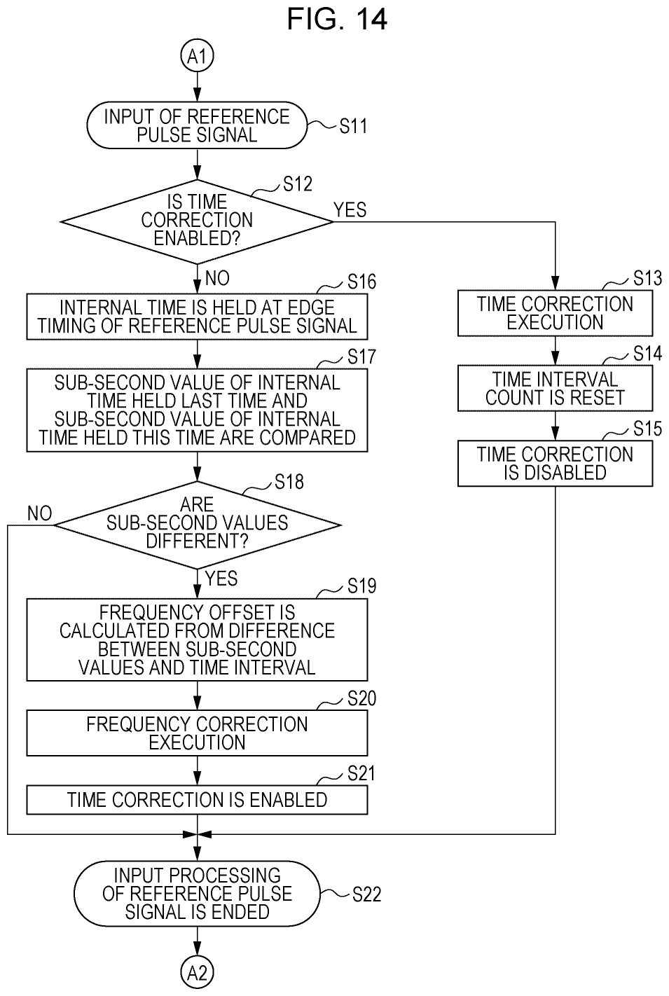

FIGS. 13 and 14 are flowcharts illustrating the operation of the real-time clock device 20 described in FIGS. 11 and 12. When the power is turned on and the real-time clock device 20 is activated, the clock count by the clock count circuit 70 is started (steps S1 and S2). In addition, as illustrated in A1 and A2 of FIG. 12, the initial time adjustment is performed using the time stamp information TMS, and as illustrated in A3, the time correction is enabled by setting the time correction valid flag (steps S3 and S4). As illustrated in A4 of FIG. 12, the input of the reference pulse signal PRF is started, and the clock count by the clock count circuit 70 is executed (steps S5 and S6).

As illustrated in FIG. 14, when the reference pulse signal PRF is input in the execution period of the clock count, it is determined whether or not the time correction is enabled (steps S11 and S12). That is, as illustrated in A3 of FIG. 12, it is determined whether or not the time correction valid flag is set. When the time correction is enabled, the time correction is executed as illustrated in A5 of FIG. 12 (step S13). When the time correction is executed, the time interval count is reset to 0 as illustrated in A6, the increment processing of the time interval count from 0 is started, and the time correction flag is cleared to 0 as illustrated in A7, so that the time correction is disabled (steps S14 and S15).

On the other hand, when the time correction flag is cleared to 0 and the time correction is disabled, the internal time is held at the edge timing of the reference pulse signal PRF (step S16). The sub-second value of the internal time held last time and the sub-second value of the internal time held this time are compared (step S17). When the sub-second value held last time and the sub-second value held this time are different from each other, and the sub-second lag, which is the time lag, is detected as illustrated in A9 of FIG. 12, the frequency offset FOF is calculated from the difference between the sub-second values, and the time interval (steps S18 and S19). That is, the frequency offset FOF is calculated based on the time lag amount TE, which is the difference between the sub-second values, and the time interval TI obtained based on the time interval count. Frequency correction is executed as illustrated in A10 based on the obtained frequency offset FOF (step S20). As illustrated in A13, the time correction valid flag is set, the time correction is enabled, and the input processing of the reference pulse signal PRF is ended (steps S21 and S22).

When the reference pulse signal PRF is next input, since the time correction is enabled, step S12 after step S11 of FIG. 14 is “YES”, and the time correction is executed as illustrated in A14 of FIG. 12 (step S13). The time interval count is reset, the time interval count from 0 is started, and the time correction is disabled by clearing the time correction valid flag as illustrated in A16 (steps S14 and S15).

As described above, in the present embodiment, the processing circuit 40 performs the frequency correction of the oscillation clock signal CK based on the time lag amount and the time interval of the time lag, and the time correction of the internal time, when it is determined that the time lag occurs at the internal time in a case in which the reference pulse signal PRF is input. For example, in FIG. 12, the processing circuit 40 executes the frequency correction of the oscillation clock signal CK as illustrated in A10, and executes the time correction as illustrated in A14, when it is determined that the time lag occurs as illustrated in A9. The frequency correction of the oscillation clock signal CK is performed based on the time lag amount TE illustrated in A9 of FIG. 12 and the time interval TI of the time lag measured by, for example, the time interval count in A6 and A11. For example, the frequency offset is obtained based on the time lag amount TE and the time interval TI of the time lag, and the oscillation frequency of the oscillation circuit 60 is adjusted based on the frequency offset, and thus the frequency correction of the oscillation clock signal CK is executed.

As described above, in the present embodiment, the reference pulse signal PRF is provided at the input terminal TPRF, and it is determined whether or not the time lag occurs at the internal time at the input timing of the reference pulse signal PRF input to the input terminal TPRF. When it is determined that the time lag occurs, the frequency correction of the oscillation clock signal CK and the time correction of the internal time are executed. As a result, the time correction for updating the internal time to the accurate time is performed, and the frequency correction for bringing the frequency error close to zero is performed. That is, the frequency offset inside the RTC is estimated and corrected based on the time information inside the RTC at the timing when the reference pulse signal PRF is input. As a result, the clock count error caused by the offset shift of the oscillation frequency due to the aging is prevented, and a highly accurate time can be provided. Therefore, the real-time clock device 20 that can provide accurate time information and maintain time accuracy can be provided. For example, by incorporating the correction function into the RTC module of one package, a highly accurate time can be provided with a small size and low power consumption.

As described above, the real-time clock device of the present embodiment that has the first mode and the second mode includes the input terminal to which the reference pulse signal of the time is input and the output terminal that outputs the synchronization pulse signal of the time. In addition, the real-time clock device includes the oscillation circuit that outputs the oscillation clock signal, the clock count circuit that generates the information on the internal time based on the oscillation clock signal, and the processing circuit. The processing circuit performs the time correction of the internal time based on the reference pulse signal input from the input terminal in the first mode, and causes the output terminal to output the synchronization pulse signal generated based on the information on the internal time, and performs the time correction of the internal time based on the reference pulse signal input from the input terminal in the second mode.

According to the present embodiment, in the first mode, the time correction of the internal time can be performed based on the reference pulse signal input from the input terminal, and the time synchronization with another real-time clock device can be performed by outputting the synchronization pulse signal from the output terminal. In addition, in the second mode, the time correction of the internal time can be performed using the synchronization pulse signal output by another real-time clock device as the reference pulse signal. Therefore, in a system having a plurality of real-time clock devices, time synchronization with a simple system configuration can be realized.

In addition, in the present embodiment, the processing circuit may set the output interval of the synchronization pulse signal in the first mode.

In this manner, the synchronization pulse signal is output at the output interval different from the input interval of the reference pulse signal, and the time synchronization with another real-time clock device can be performed.

In addition, in the present embodiment, the device may further include the interface circuit to which the output interval setting information is input, in which the processing circuit may set the output interval based on the output interval setting information.

In this manner, the output interval of the synchronization pulse signal is set by an external processing device or the like, and the time synchronization of the plurality of real-time clock devices can be realized by the synchronization pulse signal generated with the set output interval.

In addition, in the present embodiment, the device may further include the interface circuit to which the mode setting information is input, in which the processing circuit may set the control mode of the real-time clock device to the first mode or the second mode based on the mode setting information.

In this manner, the control mode of the real-time clock device can be set by an external processing device or the like, and the real-time clock device can be operated in the set control mode.

In addition, in the present embodiment, the device may further include the interface circuit to which the time stamp information is input, in which the processing circuit may cause the output terminal to output the synchronization pulse signal after setting the information on the internal time by the time stamp information.

In this manner, after the internal time of the real-time clock device is set to an appropriate time by the time stamp information, the synchronization pulse signal based on the information on the internal time can be output.

In addition, in the present embodiment, the clock count circuit may generate the time information, which is the information on at least any one of a second, a minute, an hour, a day, a week, a month, and a year, as the information on the internal time, and the processing circuit may generate the synchronization pulse signal based on the time information.

In this manner, the synchronization pulse signal can be generated by using the time information on the internal time generated by the clock count circuit, and the time synchronization with another real-time clock device can be realized.

In addition, in the present embodiment, the clock count circuit may include the first counter that counts an hour, a minute, and a second, and a second counter that counts less than a second. The processing circuit may reset the count value of the second counter in the time correction, when the internal time is ahead of the time corresponding to the reference pulse signal. In addition, the processing circuit may add the value corresponding to one second to the count value of the first counter in the time correction when the internal time is behind the time corresponding to the reference pulse signal to reset the count value of the second counter.

In this manner, even when the internal time is ahead or behind at the timing when the reference pulse signal is input, the time correction for setting the count values of the first counter and the second counter to the count values corresponding to the hour can be executed.

In addition, in the present embodiment, the processing circuit may perform, in a case in which it is determined that a time lag occurs at the internal time when the reference pulse signal is input, the frequency correction of the oscillation clock signal based on the time lag amount and the time interval of the time lag, and the time correction of the internal time.

In this manner, the time correction for updating the internal time to the accurate time is performed, and the frequency correction for bringing the frequency error close to zero is performed, so that a real-time clock device that can provide accurate time information and maintain time accuracy can be provided.

Although the present embodiment is described in detail as described above, it will be easily understood by those skilled in the art that various modifications could be made without substantially departing from the novel matters and effects of the present disclosure. Therefore, all such modification examples fall within the scope of the present disclosure. For example, a term described at least once together with a different term having a broader meaning or the same meaning in the specification or the drawings can be replaced with a different term anywhere in the specification or the drawings. In addition, all combinations of the present embodiment and modification examples also fall within the scope of the present disclosure. In addition, the configuration, operation, and the like of the real-time clock device are not limited to those described in the present embodiment, and various modifications can be made.

What is claimed is:

1. A real-time clock device that has a first mode and a second mode, the device comprising:
an input terminal to which a reference pulse signal of a time is input;
an output terminal that outputs a synchronization pulse signal of the time;
an oscillation circuit that outputs an oscillation clock signal;
a clock count circuit that generates information on an internal time based on the oscillation clock signal; and a processing circuit that performs time correction of the internal time based on the reference pulse signal input from the input terminal and causes the output terminal to output the synchronization pulse signal generated based on the information on the internal time in the first mode, and performs the time correction of the internal time based on the reference pulse signal input from the input terminal in the second mode.

2. The real-time clock device according to claim 1, wherein
the processing circuit sets an output interval of the synchronization pulse signal in the first mode.

3. The real-time clock device according to claim 2, further comprising:
an interface circuit to which output interval setting information is input, wherein
the processing circuit sets the output interval based on the output interval setting information.

4. The real-time clock device according to claim 1, further comprising:
an interface circuit to which mode setting information is input, wherein
the processing circuit sets a control mode of the real-time clock device to the first mode or the second mode based on the mode setting information.

5. The real-time clock device according to claim 1, further comprising:
an interface circuit to which time stamp information is input, wherein
the processing circuit causes the output terminal to output the synchronization pulse signal after setting the information on the internal time by the time stamp information.

6. The real-time clock device according to claim 1, wherein
the clock count circuit generates time information, which is information on at least any one of a second, a minute, an hour, a day, a week, a month, and a year, as the information on the internal time, and
the processing circuit generates the synchronization pulse signal based on the time information.

7. The real-time clock device according to claim 1, wherein
the clock count circuit includes
a first counter that counts an hour, a minute, and a second, and
a second counter that counts less than a second, and
the processing circuit resets a count value of the second counter in the time correction when the internal time is ahead of a time corresponding to the reference pulse signal, and
adds a value corresponding to one second to a count value of the first counter in the time correction when the internal time is behind the time corresponding to the reference pulse signal to reset the count value of the second counter.

8. The real-time clock device according to claim 1, wherein
the processing circuit performs, in a case in which it is determined that a time lag occurs at the internal time when the reference pulse signal is input, frequency correction of the oscillation clock signal based on a time lag amount and a time interval of the time lag, and the time correction of the internal time.
